(19) United States
(12) Patent Application Publication
(10) Pub. No.: US 2007/0136310 A1
(43) Pub. Date: Jun. 14, 2007

(54) PROCEDURE TO COLLECT, MAINTAIN, AND DISTRIBUTE WORKERS' PREFERENCES FOR PROFESSIONAL RECRUITER CONTACT

(76) Inventor: David Gerald Derrico, Los Angeles, CA (US)

Correspondence Address: David Derrico, 1484 S. Beverly Dr. #302, Los Angeles, CA, 90035, US

(21) Appl. No.: 11/563,198

(22) Filed: Nov. 25, 2006

Related U.S. Application Data
(60) Provisional application No. 60/739,967, filed on Nov. 28, 2005.

(51) Int. Cl. G06F 17/30

(52) U.S. Cl. 707/10

(57) ABSTRACT

A system for collecting, maintaining, and distributing information and preferences of workers regarding whether and how they wish to be contacted by professional recruiters (or “headhunters”). Such a system involves the workers entering identifying information (e.g., name, profession, phone number, address, etc.) and their preferences though an Internet website, email, telephone, mail, or by other method. The information is then collected into a database or pair of databases—a “whitelist” of people who wish to be contacted by professional recruiters, and a “blacklist” of people who do not wish to be contacted by recruiters. The blacklist could either be sold or distributed for free to headhunters who operate in the worker's geographic area, with instruction to the headhunter not to contact the individuals on the list. The whitelist could be sold to those same headhunters as a listing of individuals who may be interested in using the headhunters' services.

This patent application relates back to provisional patent application No. 60/739967, titled “PATENT FOR PROCEDURE TO COLLECT, MAINTAIN, AND DISTRIBUTE WORKERS' PREFERENCES FOR PROFESSIONAL RECRUITER CONTACT” and filed by David Derrico on Nov. 28, 2005, and claims priority as of that date.

### FIELD OF THE INVENTION

The present invention generally relates to a method of collecting, maintaining, and distributing workers' information and contact preferences as it relates to professional recruiters (or “headhunters”).

### BACKGROUND

The ease of communication made possible by the telephone and the use of email has had a profound effect on society. Most of these effects have been positive; however, many salespeople, telemarketers, professional recruiters, and others have seized on the telephone and email to deliver sales pitches for products or services. The ease of use, ubiquity, and low cost of these two mediums have made them particularly attractive for people wishing to reach a wide audience at low cost. Since the phone numbers and email addresses of many people are publicly available, and since salespeople have the ability to randomly dial phone numbers or send messages to random email addresses, people often have no way of turning off, avoiding, or controlling these sales calls and emails—at least not without missing important or personal phone calls or emails.

More specifically, many workers, professional workers especially, receive a high volume of calls, emails, fliers, letters, or other advertisements from professional recruiters, also known as “headhunters.” Headhunters offer a service that some, but not all, workers are interested in—namely, reputable headhunters are informed about employment opportunities, including which opportunities are available, the contact person at the employer, the qualifications of the employees the employer is looking to hire, etc. The headhunters can then offer these job opportunities to qualified candidates who would be a good match for both the employer and the prospective employee. In exchange for their services, headhunters are often paid a referral fee if the employer hires that employee and the employee maintains their employment for a specified period of time (often six months). Such referral fees can be very large, as they are customarily a percentage (often 50%) of the employee's first-year salary.

The legal profession is one uniquely suited to the services of headhunters; as such, headhunters target attorneys in large numbers and with great zeal. First, attorneys (especially at large law firms) often suffer poor, stressful working conditions, and turnover at many law firms is very high (statistics indicate that half of new lawyers leave their firm after two years, and that up to 80% of lawyers leave their original firm within five years). Put another way, a significant percentage of lawyers are unhappy with their current jobs (and searching for new, better jobs) at any given time. Second, lawyers are often compensated for tolerating the long hours and high stress of their jobs by being paid handsomely—usually well above the average starting salary for most professions. Since headhunters receive compensation by referring employees who move from one job to another, and are usually paid referral fees based on the pay of the employees they refer, the high turnover rate and high pay of attorneys make them particularly attractive candidates for a headhunter's services. (Headhunters also target other professions, notably doctors and information technology professionals.)

Not only are lawyers attractive targets for headhunters, but it is almost always very easy to obtain contact information of lawyers. Attorneys must register with the Bar of the state in which they practice, and information (including contact information) about which lawyers are authorized to practice law in each state is often freely available on state Bar web sites. Further, many companies publish a “directory of attorneys” that lists all or almost all attorneys licensed to practice law in that state, along with phone numbers and other contact information. Also, web services such as the Martindale-Hubbell Legal Directory maintain contact information about lawyers in all 50 states. Finally, lawyers often want their contact information to be freely available to prospective clients (many even advertise for this purpose), and most law firms will post names, telephone numbers, email addresses, and other information about each lawyer in the firm on the firm's website. As such, it is surprisingly easy for headhunters to amass lists of contact information with which to randomly or semi-randomly telephone, email, or mail attorneys with solicitations for the headhunter's services. A typical lawyer in a large firm will often receive five or more such solicitations from headhunters each week.

Headhunters, meanwhile, spend great a great deal of time and money attempting to reach potential new clients. As the payoff (in the form of a referral fee) is high, headhunters spend many hours searching for names and contact information of potential clients, cold-calling those people, sending emails, and drafting letters and postcards. The costs of casting such a broad net are more than just time—telephone service or long-distance costs, Internet charges, and postage and printing costs, for example, are normal costs of doing business for headhunters. These costs are only recouped if headhunters succeed in first finding and then placing a client. Headhunters are in such dire need of clients that they often even take the creative steps of publishing and sending out newsletters, or of including lottery tickets or other gifts in their correspondence to prospective clients.

While some employees are unhappy with their current employment situation and are seeking (or receptive to) the services of a headhunter, many are not. For those who are happy in their current position, unwilling to use the services of a headhunter, or simply too busy to be bothered with a sales or solicitation call during work hours, such recurring, unsolicited calls are a nuisance. For those who are searching for new employment opportunities, they may instead welcome the aid of a reputable professional recruiter, who may have knowledge and contacts regarding employment opportunities that the employee would not otherwise find out about on their own. However, even workers who are interested in using the services of a headhunter may prefer that headhunters only contact them at a certain day or time, by a certain method or at an alternate phone number or email address (due to privacy concerns with their employer or policies about using firm email for personal business), or only about certain types of employment opportunities. Unfortunately, there is no system currently in place to filter out unwanted calls and direct headhunters to only contact workers according to the parameters that the workers specify. Additionally, workers may also have no way to know if a particular recruiter who cold-calls them is reputable or not.

Therefore, the current method by which headhunters “cold-call” and otherwise randomly contact workers is inefficient and suffers from a variety of shortcomings. As detailed above, there is a disconnect between the people who are contacted by professional recruiters and those who desire their services. In other words, workers who do not wish to be contacted may be called five times in one day; meanwhile, a worker who wishes to be contacted about a certain type of job opportunity may be besieged by offers not applicable to him; sometimes, workers who wish to be contacted may receive fewer calls than they want or calls at inconvenient times when they can not answer the phone. This mismatch leads to annoyance, frustration, and missed employment opportunities on the part of the worker, and leads to wasted time, inefficiency, unnecessary expense, and lost referral fees on the part of headhunters. Since headhunters often simply call each and every professional for whom they can obtain contact information, all too often those who wish to be contacted are missed, and those who do not wish to be contacted are constantly harassed.

These drawbacks reveal the need in the art for an improved, more efficient, more profitable system by which headhunters may identify, contact, and find new employment opportunities appropriate for workers. What is needed to deal with the problem is a system wherein professionals can enter their preferences—whether they wish to be contacted or to be left alone, the time and manner of contact they prefer, the types of jobs they are interested in hearing about, etc.—into a database that is then communicated to professional recruiters. These recruiters can then contact those that desire to be contacted (those listed on the “whitelist”) according to the parameters they specify, and avoid contacting those who do not wish to be bothered (those listed on the “blacklist”). A service that captures, organizes, maintains, updates, filters, and distributes these preferences would enhance the jobs of professional recruiters and working professionals alike. Other advantages of the present invention will be apparent to one of ordinary skill in the art in light of the ensuing description of the present invention.

### SUMMARY OF THE INVENTION

The present invention is directed to a method of collecting, maintaining, and distributing workers' information and contact preferences as it relates to professional recruiters (or “headhunters”).

At a basic level, one embodiment of the invention consists of a process to capture and maintain the personal information and contact preferences of professional workers, and then to distribute those preferences to professional recruiters. The goal of the service is to match those professionals who wish to be contacted by recruiters with those recruiters, while preventing those workers who do not want to be contacted from being bothered.

Each worker who wishes to avail him- or herself of the service would indicate his name along with certain identifying information, which in various embodiments of the present invention may include his contact preference, firm name, phone number, practice area, and years of experience. The worker may also include information about the time, type, and manner of contact he or she prefers; for example, users of the service could request contact only at certain times during the day or certain days during the week, at a certain phone number other than their work phone number, by email, or only about certain types of jobs. This information will be collected and formed into one or more databases or lists. These databases track those people who have indicated their preference to be contacted by headhunters about employment opportunities (the “whitelist”), as well as those that do not (the “blacklist”). These lists may then be distributed to headhunters, who would agree to contact only those workers on the whitelist (according to their stated preferences), and avoid contacting those on the blacklist. Such an approach, which had not previously been utilized, will save time and aggravation for both headhunters and workers.

Headhunters who subscribe to the service have ready access to a group of individuals who desire the headhunters' services and whom the headhunters could place in new job positions, thus earning referral fees. Headhunters also save time, money, and frustration by not contacting people who clearly are not interested in the headhunters' services. Headhunters, who often spend significant sums of money sending fliers or gifts in order to stand out amongst their peers, would also use this service to have a connection to the people contacted and would stand out amongst the countless recruiter calls that many workers receive. And the headhunters would also know important information about the worker (such as years of experience, practice area, and type of job desired), and would be able to tailor the conversation and job offers to that particular individual's experience level and interests. This would result in a better and more productive worker/recruiter relationship, and would help recruiters place workers, while helping workers get matched up with jobs appropriate for them.

For the professional worker who is looking for the aid of a headhunter to find a new employment opportunity, headhunters will now know how to contact that worker and that the worker wants to be contacted, thus ensuring such contact. For the worker who views headhunter calls and emails as an annoyance or waste of time, is not interested in the services of a headhunter, or is content in their current job, they will be able to avoid multiple headhunter calls and emails that they have no interest in answering, thus saving time and aggravation.

The above description sets forth a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in further detail, it is to be understood that the invention is not limited in its application to the details of the construction and to the arrangement of the components set forth in the following description or as illustrated in the drawings. The invention is capable of other embodiments and of being practiced and carried out in various ways. Furthermore, it is to be understood that the phraseology and terminology employed herein are for the purpose of description and should not be regarded as limiting.

Other features, aspects and advantages of the present invention will become apparent from the following description of the invention, taken in conjunction with the accompanying drawings, which illustrate, by way of example, various features of embodiments of the invention.

### BRIEF DESCRIPTION OF THE DRAWINGS

FIG. 1 depicts a block diagram showing generally the steps of a business method in accordance with an embodiment of the present invention.

FIG. 2 depicts a flowchart showing substantially a sequence of steps of a business method in accordance with an embodiment of the present invention.

### DETAILED DESCRIPTION OF THE INVENTION

In the following description of embodiments of the invention, reference is made to the accompanying drawings, which form a part of this application. The drawings show, by way of illustration, specific embodiments in which the invention may be practiced. It is to be understood that other embodiments may be utilized and modifications may be made without departing from the scope of the present invention.

The order in which the steps are presented below is not limited to any particular order and does not necessarily imply that they have to be performed in the order presented. It will be understood by those of ordinary skill in the art that the order of these steps can be rearranged and performed in any suitable manner. It further will be understood by those of ordinary skill in the art that some steps may be omitted or added and still fall within the spirit of the invention.

The exact methodology for implementing the procedure outlined above—namely, the collection and maintenance of workers' personal and employment information and contact preferences, and the conveyance of that information to headhunters—can take many forms.

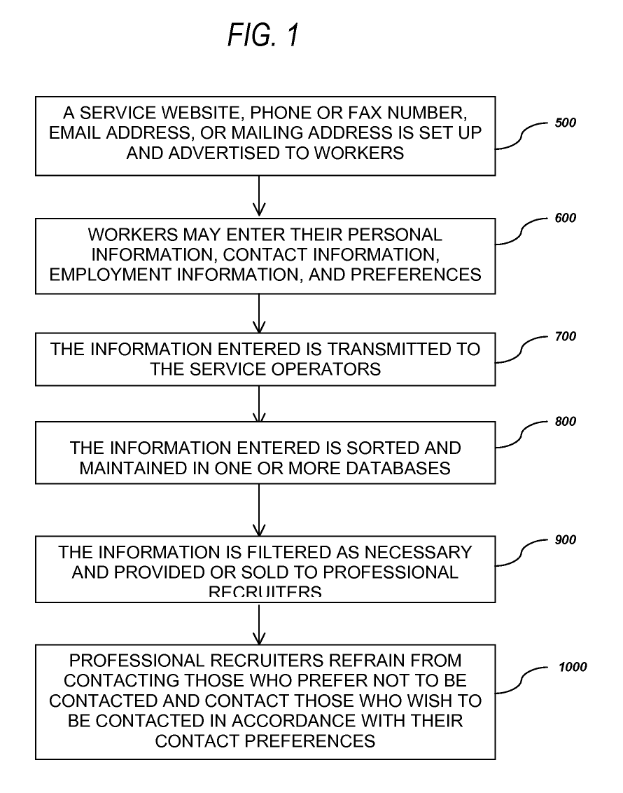

The first step for the person or persons operating the service is to advertise to the types of professionals who use the services of headhunters (e.g., lawyers, administrators, doctors, engineers, etc.) regarding the service (FIG. 1, step 500). Workers interested in using the service will be able to enter their personal information, contact information, employment information, and contact preferences (step 600), and transmit that information to the service operators (step 700). For example, the service could set up an Internet website, an email address, a telephone number, a facsimile number, a mail address or P.O. Box, or even a staffed physical location to receive information. Workers could then (1) access the website and enter their information and preferences through the use of a web form, which would transmit the data to the service operators, (2) compose an email containing their information and preferences and send it to the service operators at the email address provided, (3) call the service operators by telephone, where they may speak to a live person who asks for and makes note of their information and preferences, or hear a taped message that asks them to leave their information and preference to be recorded and input later, or (4) compose a letter or other writing containing their information and preferences and mail or fax it to the service operators' mailing address. The transmission of such information, and inclusion on the resulting list or database (explained further below) would likely be without cost (or at a nominal cost) to the workers availing themselves of the service by entering the information.

The minimum information about an individual necessary for the service to be effective is the individual's name, occupation, and contact preference, i.e. whether the worker wishes to be contacted by headhunters or not. Typically, the information collected would also include a phone number (from which a state or region may be determined), the name of the employer, the field or practice area within the occupation, and the worker's number of years of experience. In various alternate embodiments of the present invention, the information collected from workers may consist of a subset from the following: personal identifying information including name and social security number; contact information including work phone number, home phone number, cellular phone number, fax number, email address, and mailing address; employment information including occupation, employer name, practice area or professional specialty, years of experience, special qualifications, professional licenses or affiliations, a current resume, new region the employee is considering moving to, timing of anticipated job move, current salary, and desired salary; contact preferences including preferred times or days of contact, preferred method of contact, and type of job sought; and other information including optional notes, time of information entry, internet protocol address, and whether the user is a new user or a returning user updating his or her information. In various alternate embodiments, the information collected may also include other information that relates to the individual worker's specific occupation and is customarily used by headhunters or employers in that field in screening potential candidates or matching candidates with job openings. For example, an attorney may have the option to enter information relating to his or her client list, the amount of portable business he or she has, examples of important litigation or deals he or she has worked on, which courts he or she is licensed to practice in front of, etc. Such information will necessarily vary by profession or practice area, but will be of the type that keeps with the spirit of the invention by relating to the employee's professional career and employment search. Which additional fields may be added may, of course, also change over time (e.g., fields for computer experience or email address might be relevant now but not in the past), but would be reasonably understood and expected by those skilled in the art.

In various alternate embodiments of the invention, some of the information entered may be mandatory (e.g., the name, phone number, and preference must be entered in order to use the service), while other information may be optional (e.g., the worker may have the option of inputting his or her email address or employer's name, but may still use the service without inputting such information).

In addition to the information that an employer may enter in fields of a web form, or on an email or other writing, or over the telephone (as described above), there could also be an option for the worker to upload or send a current resume, photograph, or other additional information to be distributed to headhunters along with the individual's information. Whatever different data fields and attachments are collected about each worker will herein be collectively referred to as the individual's “information.”

Whatever specific types of information are collected, and however the information is transmitted, the service operators will collect the information in a list or database matching the name, contact information, preference, etc. for each individual worker who uses the service (step 800). Such information may be maintained using popular computer database or spreadsheet programs (such as Microsoft Excel or Access, Filemaker, etc.), or manually on a list. The data can be organized and inputted manually, or through the use of web server scripting languages (e.g., PHP: Hypertext Preprocessor) and software including MySQL, depending on how it is received.

Once the data is collected into a list or database, the information may be sorted or filtered according to various criteria (geographic region, amount of experience, practice area, etc.), and sold or otherwise provided and transmitted to headhunters (step 900). In various alternate embodiments of the present invention, the databases created may be sold either in full or in parts, filtered according to certain criteria (occupation, geographic region, amount of experience, etc.), sold exclusively to one headhunter or to many different headhunters, or may be auctioned or sold through a recurring subscription-based service.

The headhunters who use the service and receive the information will then refrain from contacting those people who requested not to be contacted, and will contact those who requested to be contacted, but only according to the time, manner, and specifications the worker requested (step 1000).

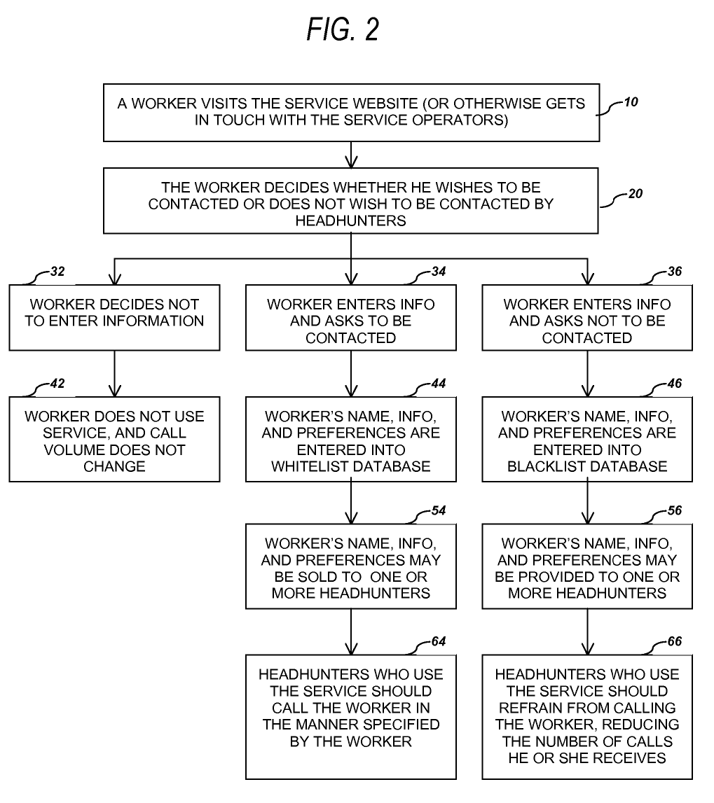

Turning now to FIG. 2, in one embodiment of the present invention, a worker may visit a website, call a phone number, write an email, or otherwise get in touch with the service operators (step 10). The worker may then decide whether or not he is looking for a new job, and whether or not he wishes to be contacted by headhunters (step 20). The worker may then decide not to enter his information (step 32), to enter his information and preferences and ask to be contacted by headhunters (step 34), or enter his information and ask not to be contacted (step 36). If the worker enters his information, that information is stored in one or more databases, according to whether he asked to be contacted or not (steps 44 and 46). If the worker asked to be contacted, his information will likely be sold to one or more headhunters (step 54), and those headhunters should contact the worker at the time and in the manner in which the worker specified, and about the types of jobs desired by the worker and appropriate for the worker's experience level (step 64). If, however, the worker had decided not to be contacted, then the worker's information may be provided to headhunters with instructions not to contact the worker (step 56), and the worker should notice a corresponding decrease in the number of phone calls he receives, as headhunters who use the service should refrain from calling that worker (step 66).

Due to the high costs and high failure rate of contacting prospective clients described above, headhunters would find a list of workers who are interested in their service extremely valuable, even more so if that list includes information about the workers' job experience, preferred contact method, and area of practice. Headhunters would also find a list of workers who are clearly uninterested in their services to be valuable as well, since it would save them time and money by allowing them to avoid contacting those people and instead focus on other prospective clients. As such, one embodiment of the present invention may—depending on the economic realities and supply and demand of this novel procedure—likely sell portions of or the complete list or database to headhunters, and may offer to give away for free a list of only those workers who indicated a preference not to be contacted. By employing such an embodiment, as many headhunters as possible would use the “blacklist” and avoid calling those people, thus enhancing the attractiveness of the service to the workers who will use it. In various embodiments, the sale of the “whitelist” to headhunters could take many forms, including a sale of the full list, sale of individual workers' information, an auction of the information or portions of the whitelist, or a recurring, subscription-based service.

The distribution (whether for a fee or without cost) of the information list will include the ability of the service operators to filter, sub-divide, or otherwise maintain the lists to cater to specific geographic areas and professional occupations. For example, a headhunter who operates and seeks jobs for clients only in southern California would likely only be interested in a list of candidates who are from, or are seeking employment in that area. Similarly, a headhunter who only performs employment placement for attorneys will likely only be interested in receiving information and preferences of attorneys. As such, various embodiments of the service will likely include a procedure for sub-dividing (or filtering) the master list or database according to the needs of the headhunters requesting the information. Such sorting and sub-division could be accomplished by various commercial database or spreadsheet software programs. Various prices may be charged for various subsets of the full list, depending on the criteria used to filter the list.

Workers using the service may also elect to re-submit their information (using any of the methods described above) as their contact information or preferences change. For example, workers who are happy with their current job at one point may change their mind later and find themselves desiring a new job and the services of a headhunter in obtaining that job. Workers may also change their contact information from time to time, or their preferred method of contact. The system would allow workers to update their information, which could be reconciled with existing information based on the worker's name, region, and other identifying information, and updated in the database as appropriate. The updating feature may also be performed by adding a data field where the worker indicates if the information he or she is submitting is new, or an update to a previous entry. Alternately, the use of a computer web site may use “cookies,” which can track visitors to a site and determine if they are new or returning visitors. In such a case, the previously-entered information can be automatically populated in the submission form fields when the returning user visits the web site.

### Conclusion and Alternate Embodiments

It can be realized from the embodiments described herein that the present invention provides a new and improved framework under which headhunters may identify prospective clients who are desirous of their services, and better tailor the employment opportunities they offer, resulting in a higher placement rate and more satisfied workers and headhunters alike. The above-described embodiments of the present invention have many advantages.

For instance, workers who do not desire headhunter contact may opt out of such contact, thus providing them with more control, and saving them time and possibly aggravation. Workers who do desire contact may sign up with the service and improve their chances of prompt contact from a reputable headhunter—and workers who use the service will be contacted (a) only be reputable headhunters on an approved list, (b) at the time, place, and manner in which the worker specifies as most convenient, (c) only about the types of jobs that the worker is interested in hearing about, (d) about jobs in the worker's own geographic area and area of practice or expertise, and (e) about jobs specifically tailored as appropriate to the worker's experience level, quality of experience, and special qualifications.

For headhunters, there are also many advantages. Headhunters can save time, money, and aggravation of their own by avoiding “cold-calling” a long list of candidates who are likely not interested in their services or who are not looking for new employment opportunities. Headhunters may instead purchase a list of candidates who are interested in speaking to a recruiter and who are currently looking to switch jobs. The workers contacted through this system are likely to be far more receptive to the headhunter's pitch if the headhunter identifies himself as being a user of the service and explains that he or she received the worker's information through the worker's own input of that information, as described above. Headhunters may also focus on candidates that fit the types of job listings they are looking to fill—they may target only those candidates who have the appropriate expertise or experience. In sum, headhunters can save a great deal of time by focusing on viable candidates instead of using phone books and other unfiltered sources to canvass all workers in a given geographic region. Headhunters will have a far better chance to place a candidate from a filtered list of interested workers than they will to place a random worker from the phone book.

It is to be understood that although some advantages of the present invention are described herein, it is not necessary that all the advantageous features and/or all the advantages need to be incorporated into every embodiment of the invention.

Although the present invention has been described above in considerable detail with reference to certain versions thereof, other versions are possible. For example, the information may be collected by any number of different methods without departing from the spirit and scope of the invention. While information can be easily collected using an Internet-based web form, information may be collected by telephone, email, facsimile transmission, in person, or by regular mail. The information collected may include more, fewer, or different specific fields than described herein, and those fields may differ depending on the worker's occupation and may evolve over time. Various fields may also be required in order to use the service, and the input of information into other fields may be at the worker's option. Once collected, the information may be maintained by use of any number of computer spreadsheet programs, but it may also be maintained using other electronic means or by pen and paper without departing from the scope of the invention. Similarly, the exact methodology by which the information is sold to headhunters may vary from a flat fee charged for each candidate to some form of auction or subscription-based service. Also, the information may be transmitted to headhunters in a number of different ways, including by email or postal mail.

Additionally, some steps of the method described herein may be added, omitted or modified. For instance, only some of the possible types of information may be collected, or one or more websites may be set up that are tailored only to workers that either do or do not desire to be contacted; for example, in one alternate embodiment, workers will only enter their name and information if they desire to be contacted, and the “do not contact me” option may not be present.

While the description above refers to particular embodiments of the present invention, it will be understood that many modifications may be made without departing from the spirit thereof. The presently disclosed embodiments are therefore to be considered in all respects as illustrative and not restrictive.

What is claimed is:

1. A method of collecting and maintaining names of workers along with information provided by workers, comprising:
a. collecting a set of information from workers, said information comprising data that identifies those workers, provides one or more methods for contacting the workers, relates to the workers' individual profession and is customarily used by professional recruiters or employers in the workers' particular field in making employment decisions or matching candidates with prospective job openings, and identifies the workers' preferences regarding when, by what method of communication, and about what types of jobs those workers wish to be contacted;
b. maintaining said information in a list or database; and
c. distributing at least a portion of said information to professional recruiters.

2. The method of claim 1, wherein one or more Internet websites are used to collect the information.

3. The method of claim 1, wherein one or more Internet websites are used to collect the information through the use of a form, wherein the worker may enter the information into various form fields, and then submit the information, which is collected by programs written in web server scripting languages and imported into a chart or database through use of commercially-available or free software.

4. The method of claim 1, wherein the information is collected by one or more of the following methods: receiving emails from workers, receiving phone calls from workers, receiving postal mail letters from workers, and receiving facsimile transmissions from workers.

5. The method of claim 1, wherein workers can update the information that was previously entered as the information changes.

6. The method of claim 1, wherein at least a portion of the information collected is sold to professional recruiters.

7. The method of claim 1, wherein the information received is filtered according to various criteria and sorted into sub-databases based on contact preference, occupation, practice area, years of experience, geographic region, or such other data fields as professional recruiters may desire to match up with the types of clients that professional recruiters serve, and where professional recruiters may purchase at least a portion of the sub-databases.

8. The method of claim 1, wherein the information received is sorted into two separate lists comprised of: a “whitelist” of workers willing to receive professional recruiter communications, and a “blacklist” of workers who are not willing to receive professional recruiter communications.

9. The method of claim 8, wherein the whitelist is sold to professional recruiters, and the blacklist is provided to professional recruiters for free.

10. The method of claim 1, wherein workers only enter the information if they desire to be contacted by professional recruiters, and the resulting whitelist is sold to professional recruiters without any accompanying list of workers who do not wish to be contacted by professional recruiters.

11. The method of claim 1, wherein the information received is sold by one or more of the following methods: sales of the information of one or more workers to an individual professional recruiter or professional recruiters, a recurring subscription-based service where a new list is distributed to professional recruiters monthly, weekly, daily, or at some other interval, and an auction of at least a portion of the list to a pool of numerous professional recruiters.

12. The method of claim 1, wherein the information is collected from attorneys, and comprises additional attorney-specific classes of information comprising:
information about clients or amount of business brought in by the attorney, courts the attorney is licensed to practice before, significant cases, lawsuits, or deals the attorney has worked on, position within the attorney's current firm (i.e., associate, senior associate, of counsel, or partner), and type of legal area the attorney specializes in.

13. A method of collecting and maintaining information, comprising names of workers along with personal information, contact information, employment information, and contact preferences, said method comprising:
a. collecting said information from workers, which comprises: personal information such as name and social security number; contact information such as phone number, fax number, or email address; employment information such as occupation, employer name, practice area or professional specialty, years and types of experience, and special qualifications; and contact preferences such as preferred times or days of contact, preferred method of contact, and type of job sought;
b. maintaining said information in a list or database; and
c. distributing at least a portion of said information to professional recruiters, wherein at least some of the information provided to professional recruiters is sold.

14. The method of claim 13, wherein one or more Internet websites are used to collect the information.

15. The method of claim 13, wherein workers can update the information that was previously entered as the information changes.

16. The method of claim 13, wherein the information received is filtered according to criteria and sorted into sub-databases based on contact preference, occupation, practice area, years of experience, geographic region, or such other data fields as professional recruiters may desire to match up with the types of clients that they serve, and where professional recruiters may purchase at least a portion of the sub-databases.

17. The method of claim 13, wherein the information received is sorted into two separate lists comprised of: a “whitelist” of workers willing to receive professional recruiter communications, and a “blacklist” of workers who are not willing to receive professional recruiter communications.

18. The method of claim 13, wherein workers only enter the information if they desire to be contacted by professional recruiters, and the resulting whitelist is sold to professional recruiters without any accompanying list of workers who do not desire to be contacted by professional recruiters.

19. The method of claim 13, wherein the information received is sold by one or more of the following methods: sales of information and preferences of one or more workers to an individual professional recruiter or professional recruiters, a recurring subscription-based service where a new list is distributed to professional recruiters monthly, weekly, daily, or at some other interval, and an auction of at least a portion of the list to a pool of numerous professional recruiters.

20. A method of collecting and maintaining information, comprising names of workers along with personal information, contact information, employment information, and contact preferences, said method comprising:
a. collecting said information from workers by one or more of the following methods: use of an Internet website, by receiving emails, by receiving phone calls, by receiving postal mail, and by receiving facsimile transmissions from workers, where said information comprises: name, social security number, work phone number, home phone number, cellular phone number, fax number, email address, mailing address, occupation, employer name, practice area or professional specialty, years and types of experience, special qualifications, professional licenses and affiliations, information about clients, profession-specific information, a current resume, new region the employee is considering moving to, timing of anticipated job move, current salary, desired salary, preferred times or days of contact, preferred method of contact, type of job sought, optional notes, time of information entry, internet protocol address, and whether the user is a new user or a returning user updating his or her information;
b. maintaining said information in one or more of the following formats: in a list, database, spreadsheet, text file, and handwritten format; and
c. distributing at least a portion of said information to professional recruiters, wherein the information distributed may be filtered based on various criteria and wherein the information is sold to professional recruiters.
